(19) United States
(12) Patent Application Publication
(10) Pub. No.: US 2026/0058511 A1
(43) Pub. Date: Feb. 26, 2026

(54) Reduced Air Gap Magnet Support for Permanent Magnet Machines

(71) Applicant: Hinetics LLC, Champaign, IL (US)

(72) Inventors: Noah Salk, Champaign, IL (US); Jianqiao Xiao, Champaign, IL (US); Kiruba S. Haran, Champaign, IL (US)

(21) Appl. No.: 18/812,332

(22) Filed: Aug. 22, 2024

(51) Int. Cl. H02K 1/28; H02K 1/2792; H02K 21/22

(52) U.S. Cl. CPC H02K 1/28; H02K 1/2792; H02K 21/22

(57) ABSTRACT

A high-efficiency, high specific power electric motor/generator provides a set of permanent magnets retained at their axial ends by a wedge interface minimizing structure between the magnets and electrical coils to maximize magnetic coupling and torque production.

### BACKGROUND OF THE INVENTION

The present invention relates to electrical machines suitable for use in aircraft and, in particular, to a high-efficiency, high-power density electric motor design.

Electrical motors for aircraft application require high efficiency, for example, to take advantage of energy storage devices such as batteries and the like, and high specific power (power per weight) to reduce unnecessary aircraft weight.

U.S. patent application Ser. No. 17/661,819 filed May 3, 2022, incorporated by reference, and assigned to the assignee of the present invention, describes a permanent magnet motor with an external or outside rotor supported from the shaft of the motor in cantilever by an endplate. An optimized motor design requires an extremely narrow gap between the rotor and the stator, usually one or two millimeters. This necessitates an extremely high shaft stiffness usually addressed by adding more shaft material which reduces the motor specific power and, in some cases, efficiency.

### SUMMARY OF THE INVENTION

The present invention allows a reduction in the gap between the rotor and stator by attaching the permanent magnets to a support structure using a wedge interface displaced to the axial ends of the permanent magnets. In this way, magnet retention structure is eliminated from the space between the magnets and the electrical coils while still providing strong retention of the magnets and the ability to apply a clamping force by moving the wedges together.

In one embodiment, the invention provides an electrical machine with a stator and a rotor, the rotor rotating about an axis relative to a stator and positioned proximate to the stator for magnetic interaction therewith. A magnet support assembly attaches to one of the rotor or stator and provides a tubular magnet backer and a series of axially extending permanent magnet bars arrayed about the axis on a surface of the tubular backer support to present exposed faces away from the tubular magnet backer. The magnet bars have axially opposed ends presenting end faces having an interior oblique angle with respect to the exposed face. Magnet retention wedges flank the permanent magnet bars and have wedge faces with interior acute angles with respect to the exposed faces of the permanent magnet bars and are positioned in contact with the end faces of the permanent magnet bars to press the permanent magnet bars against the tubular magnet backer as the wedges move together about the permanent magnet bars.

It is thus a feature of at least one embodiment of the invention to provide an attachment mechanism for permanent magnets that can provide a clamping that accommodates variations in magnet size without introducing structure between the magnets and the electromagnetic coils that would reduce magnetic coupling by increasing gap size. The broad contact surface of the wedge and magnet provide sufficient support for the high forces on the magnet despite being limited to end locations and by the inherent brittleness of the magnet material.

At least some magnet retention wedges may provide axially opposed wedge faces with interior acute angles with respect to the exposed faces of the permanent magnet bars, the opposed wedge faces contacting the corresponding axial ends'permanent magnet bars.

It is thus a feature of at least one embodiment of the invention to provide extended axial length in the rotor while maintaining tractable magnet sizes.

The wedge faces may be provided by continuous rings having an inner surface adjacent and conforming to a circumferential surface of the tubular magnet backer.

It is thus a feature of at least one embodiment of the invention to provide a simple architecture for producing the necessary wedge surfaces offering improved manufacturability.

The inner surface of the continuous rings may present a portion of a key and key way limiting axial movement of the inner surface with respect to the tubular magnet backer.

It is thus a feature of at least one embodiment of the invention to permit a positive axial locking of the rings for improved reliability. The keyway may provide for limited axial movement for adjustment while allowing fixation to an adhesive or frictional contact.

In some embodiments, an adhesive may also be used to join the permanent magnet bars to the tubular magnet backer.

It is thus a feature of at least one object of the invention to provide a system that can implement a clamping of the magnet bars using the wedge elements in conjunction with an adhesive.

The magnets may provide a Halbach array in a progression around the axis.

It is thus a feature of at least one embodiment of the invention to eliminate the need for a ferromagnetic backer material for flux concentration by proper phasing of the magnet polarities.

The magnet bars may be polyhedrons having all interior angles of no less than 80°.

It is thus a feature of at least one embodiment of the invention to provide a clamping mechanism that accommodates the brittle nature of the permanent magnet bars allowing a system with no acute angle subject to chipping.

The electrical machine may further include an adhesive material applied between the axially extending magnet bars and over portions of the exposed faces to present a continuous surface.

It is thus a feature of at least one embodiment of the invention to remove surface irregularities in the magnet array causing increased air resistance in the much reduced possible air gap between the magnets and the electromagnetic coils.

The exposed faces of the permanent magnets may be directed away from the axis.

It is thus a feature of at least one embodiment of the invention to provide an attachment mechanism that can handle the high accelerated forces in this type of electrical machine where an end magnet backer is not available for that purpose.

The rings may be a composite material providing circumferential axial fibers.

It is thus a feature of at least one embodiment of the invention to provide rings with extremely high tensile force resistance particularly useful when the permanent magnets are facing outward.

An air gap between the exposed faces of the magnet bars and structure of the electromagnetics assembly may be free of intervening material of the wedges.

It is thus a feature of at least one embodiment of the invention to provide a retention mechanism that does not require an additional air gap to accommodate a retention structure.

These particular objects and advantages may apply to only some embodiments falling within the claims and thus do not define the scope of the invention.

### BRIEF DESCRIPTION OF THE DRAWINGS

FIG. 1 is an exploded perspective view of the electric machine of the present invention showing the inter-fitting of an external rotor around the central stationary stator in one embodiment;

FIG. 2 is an isolated view of the external rotor (reversed in orientation from FIG. 1) showing an internal array of bar magnets held on a tubular support structure and retention wedges;

FIG. 3 is aligned front elevational and end elevational views of the magnets of FIG. 2 showing tapered ends for magnet mounting;

FIG. 4 is a perspective view of the magnet of FIG. 3;

FIG. 5 is an exploded view of the magnet support structure and magnets of FIG. 2 showing wedge elements used to attach the magnets to the support structure with the axial assembly, also showing one wedge element in cross-section as an inset;

FIG. 6 is a fragmentary cross-section along the rotational axis of FIG. 5 showing orientation of the magnet polarities to produce a Halbach array;

FIG. 7 is a fragmentary cutaway view of the rotor of FIG. 2 showing the interface between the wedge elements and the bar magnets;

FIG. 8 is a fragmentary cross-sectional view along the plane of the rotational axis showing the magnet support structure when multiple magnet ranks are provided; and

FIG. 9 is a fragmentary view of the invention applied to an internal rotor.

### DETAILED DESCRIPTION OF THE PREFERRED EMBODIMENT

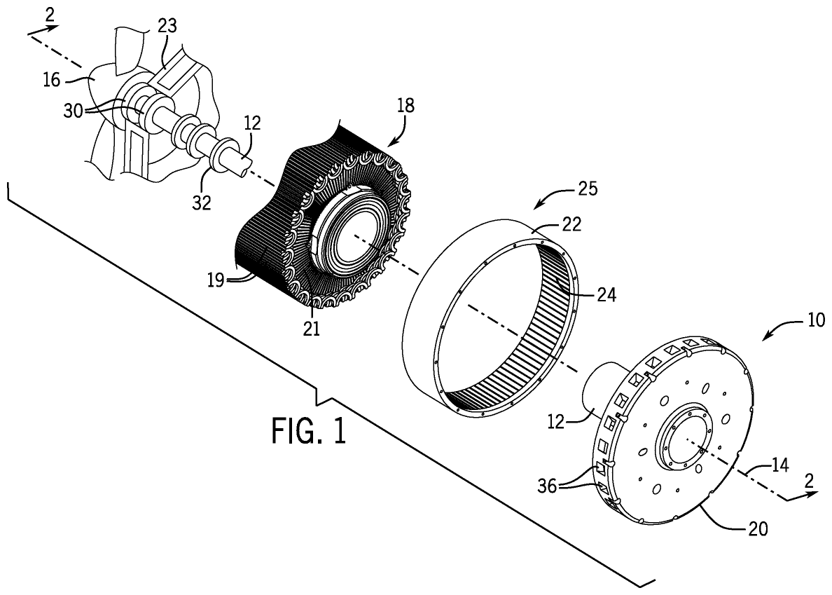

Referring now to FIG. 1, an electrical machine 10 of the present invention may provide for a central shaft 12 extending along an axis 14 about which the shaft 12 may rotate. The shaft may communicate at a first end with a propeller 16, engine, generator, or similar load, the propeller 16 receiving torque from the electrical machine 10 during operation of the electrical machine 10 as a motor and providing torque to the electrical machine 10 during operation of the electrical machine 10 as a generator during regeneration. The shaft 12 may be a hollow tube to maximize torque transmission with minimized weight.

A front end of a stator 18 may be attached to a fixed structure, for example, an aircraft frame 23 or the like, the outer surface of the stator 18 exposing a set of electrically independent electrical coils 19 arrayed thereabout and extending axially there along. A set of heatsink fins 21 may extend inwardly from the electrical coils 19 toward the shaft 12 but spaced therefrom to conduct heat away from the electrical coils 19.

The shaft 12 may pass rearwardly from the propeller 16 through the center of the stator 18 and through an opening in the heatsink fins 21 to be received by an endplate 20 of a rotor 25 fixed to the shaft 12 to rotate therewith. The endplate 20 extends radially from the shaft 12 to an outer periphery outside that of the stator 18. At this outer periphery, the endplate 20 attaches to a rearward lip of a cylindrical, tubular magnet support 22 being part of a rotor 25 that may fit coaxially around the stator 18. The magnet support 22 includes a set of internal affixed permanent magnet bars 24 that may interact with the electrical fields from the coils 19 as is generally understood in the art.

The endplate 20 may provide a set of regularly spaced openings 36 therethrough. These openings 36 may communicate with an inner radial surface of the endplate 20, the latter supporting impeller fan blades to conduct air captured by the fan blade through the openings 36 for cooling.

The shaft 12 may be supported by a first set of bearings 30, for example, a pair of ball or roller thrust bearings, spaced apart axially to restrain motion of the shaft 12 to rotational motion about the axis 14 only, as braced against the aircraft frame 23. The first set of bearings 30 as so positioned largely absorbs axial and radial forces acting on the shaft 12. Likewise a second portion of the shaft 12 may be supported on a second set of bearings 32 between the shaft 12 and an inner surface of the stator 18. This second set of bearings 32 may also be a pair of ball or roller thrust bearings spaced axially. The second set of bearings 32 preserves the gap between the stator 18 and magnet support 22 without a need to resist significant radial or thrust forces perpendicular or along axis 14 from the propeller 16. In this way, bearing restraint of the inner surface of the magnet support 22 and the outer surface of the stator 18 can be done with a lightweight shaft and bearing system and can be insufficiently stiff to prevent the full forces of the propeller 16 from disrupting the narrow gap between the stator and rotor.

Additional details for the construction of the stator 18, rotor 25, and the magnet support 22 are provided in U.S. patent application Ser. No. 17/661,819 cited above.

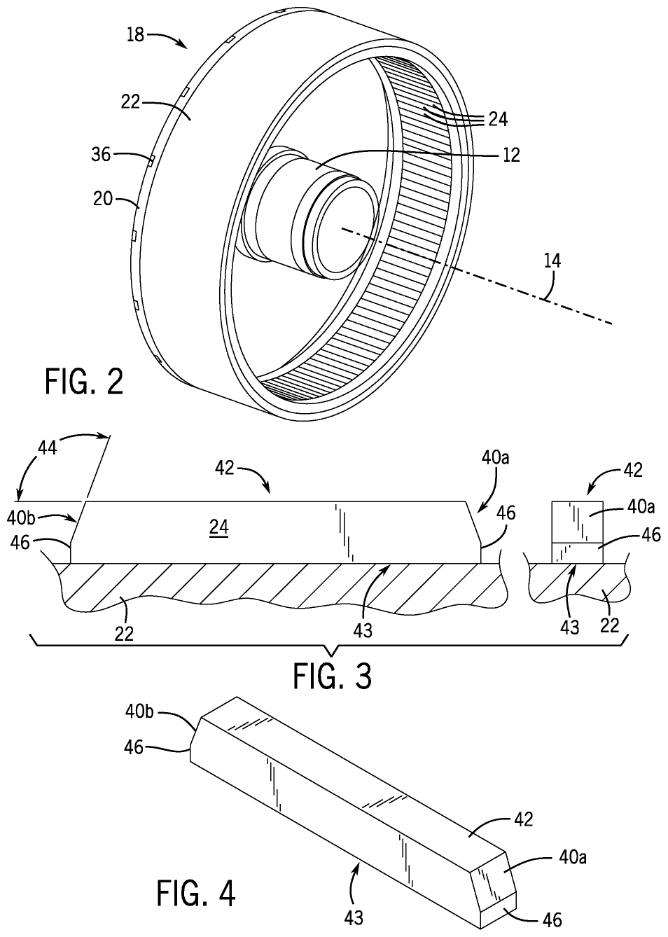

Referring now to FIGS. 1 and 2, as noted above, the inner surface of the magnet support 22 may hold a set of bar permanent magnet bars 24 having a longest dimension extending parallel to the axis 14 and arrayed circumferentially adjacent about the axis 14 to follow the inner cylindrical surface of the magnet support 22.

Referring also to FIGS. 3 and 4, each permanent magnet bar 24 may be a polyhedron having a generally rectangular cross-section taken perpendicular to a line parallel to the rotational axis 14. Each permanent magnet bar 24 provides two axially opposed end faces 40a and 40a flanking an exposed face 42 of the permanent magnet bar 24. The exposed face 42 will be generally parallel to the axis 14 and opposite a parallel inner face 43 of the permanent magnet bar 24 adjacent to the magnet support 22.

An included angle 44 between the exposed face 42 and each of the end faces 40a and 40b of the permanent magnet bar 24 will be obtuse and typically within a range greater than 95° and typically greater than 100°. All remaining angles between adjacent faces of the permanent magnet bars 24 may be 90° or greater to eliminate acute angles susceptible to damaging the brittle material of the permanent magnet bars 24 as they are constructed with rare earth alloys. This elimination of acute angles may be enforced by providing a slight flat 46 between the end faces 40a and 40b and the inner face 43 as shown.

Referring now to FIGS. 2, 4, and 7, the magnets 24 may be retained against the inner surface of the magnet support 22 by wedge rings 50a and 50b circumferentially flanking, respectively, the permanent magnet bars 24 and contacting and end faces 40a and 40b of the permanent magnet bars 24 arrayed against the inner surface of the magnet support 22. A cross-section of each wedge ring 50a and 50b provides a wedge face 52 fitting adjacent to corresponding end faces 40a and 40b. An interior angle 56 of the wedge face 52, with respect to an exposed face 57 of the wedge ring 50 parallel to the axis 14 (and with respect to the exposed face 42 of the permanent magnet bar 24 when assembled therewith), will typically be less than 85° or less than 80° to be complementary with the respective angles of the adjacent end faces 40a and 40b. More generally the angles of the end faces 40a and 40b will be parallel with the angle of the corresponding wedge faces 52 when fit together.

A parallel side 58 of the wedge ring 50 opposite the exposed face 57 may include a key 60 fitting within a keyway 63 cut circumferentially in a radially outward direction in the inner surface of the magnet support 22. This key 60 and keyway 63 to help locate the wedge ring 50 within the magnet support 22 and resist axial shifting.

The wedge ring 50 may be installed by a shrink fitting process and may be constructed of a material such as aluminum, titanium, or steel. In some embodiments the wedge ring 50 will be a composite material with circumferentially directed tensile fibers of Kevlar, glass, or the like. The materials of the wedge ring 50 will generally be such as to resist damage of acute angles in the wedge ring 50; however, in some embodiments additional flats similar to flat 46 shown in FIGS. 3 and 4 may be provided to eliminate such acute angles.

Generally, the exposed face 57 of the wedge ring 50 will be equal in height (measured radially with respect to the axis 14) or slightly recessed below the corresponding exposed face 42 so that no material of the wedge ring 50 is positioned between the magnets 24 and the stator 18 and the wedge ring 50 does not protrude above the exposed face 42 to necessitate additional space between the magnets 24 and the stator 18.

An adhesive material such as epoxy may also be placed between circumferentially adjacent permanent magnet bars 24, and a thin layer of material 67, for example, epoxy possibly reinforced with circumferential fibers or a separate composite sleeve serving the same function may be applied over the exposed faces 42 of the assembled permanent magnet bars 24 to present a continuous and smooth cylindrical surface centered about axis 14 operating to reduce windage losses from air friction in the gap between the exposed faces 42 and corresponding structure of the stator 18.

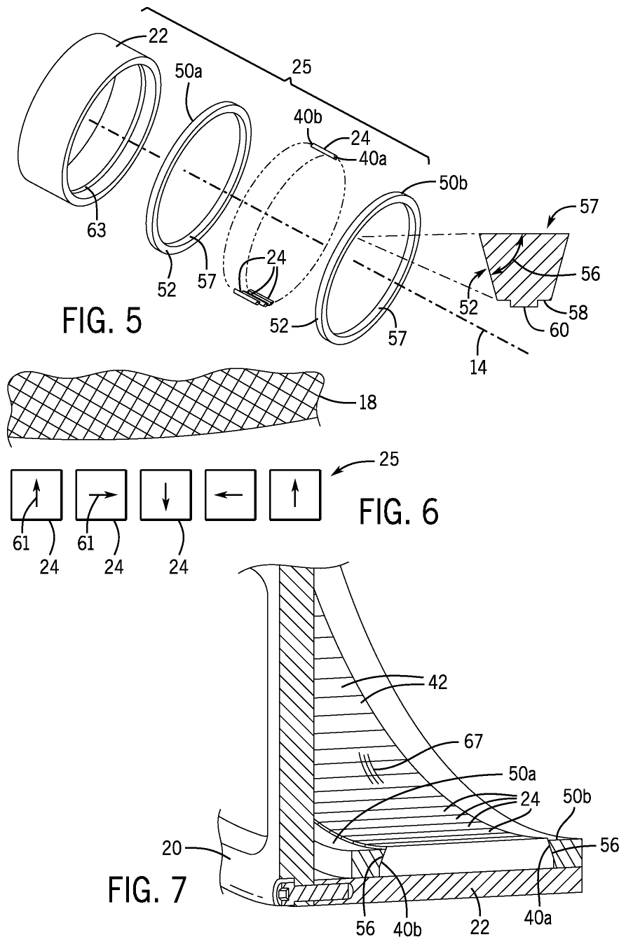

As will be understood from this description, small dimensional changes in the permanent magnet bar 24 can be accommodated by axial sliding of one or both of the wedge rings 50 while preserving their positive support of the permanent magnet bars 24. A relatively steep interior angle 56 allows a strong clamping of the permanent magnet bars 24 with minimal axial motion of the wedge rings 50, reducing the necessary repositioning of the wedge rings 50 needed to clamp the permanent magnet bars 24, such repositioning as may be accommodated by appropriate tolerances in the key 60 and keyway 63 shown in FIG. 5.

Referring now to FIG. 6, the circumferentially adjacent permanent magnet bars 24 may have polarities 61 arranged to produce a so-called Halbach array in which the magnet polarity 61 is rotated by 90° with each successive circumferential permanent magnet bar 24. This arrangement reduces the projection of the magnetic flux lines of the permanent magnet bars 24 toward the magnet support 22 while promoting flux on the exposed faces of the permanent magnet bars 24. This arrangement eliminates the need for a ferromagnetic material in the magnet support 22 to constrain the magnetic flux, instead allowing lightweight materials, including composites, to be used for this purpose.

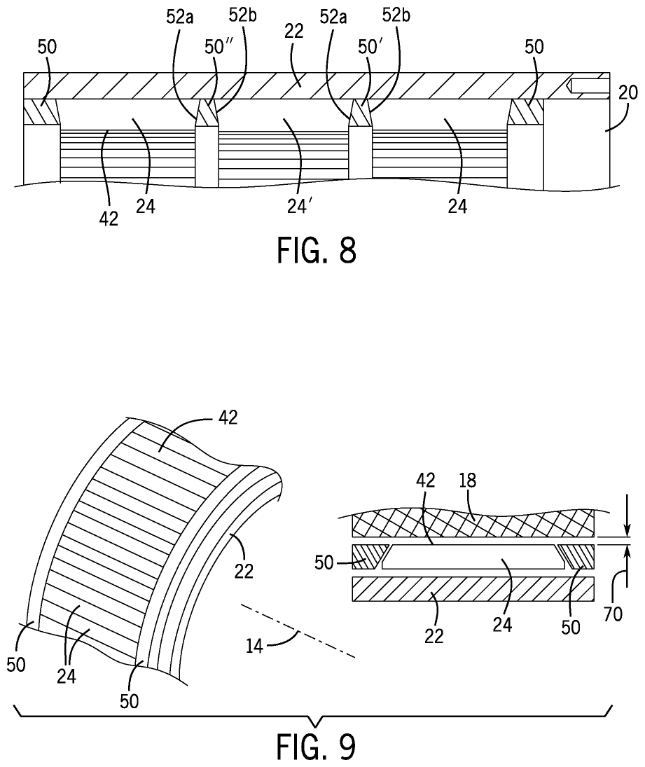

Referring now to FIG. 8, the axial length of the permanent magnet bars 24 may be limited for strength and manufacturability while still providing a substantial axial length of the rotor 25 by employing intermediary rings 50′ having axially opposed wedge faces 52a and 52b that may flank interior permanent magnet bars 24′. In other respects, this configuration will conform to the description above with respect to FIGS. 1-7.

Referring now to FIG. 9, although the above description has, for simplicity, focused on an inboard configuration of the permanent magnet bars 24 attached to an inner circumference of the magnet support 22 and having exposed faces 42 facing inwardly toward the axis 14, it will be appreciated that an outboard configuration may also be employed where the stator 18 is positioned outside of the rotor 25 and the permanent magnet bars 24 have their exposed faces 42 facing radially outward with respect to the rotational axis 14. In this case the outward accelerated forces of the permanent magnet bars 24 may be retained by rings 50 shrink fit on an outer circumference surface of the magnet support 22. The extremely narrow air gap 70 that can be obtained with this configuration and the inboard configuration described above is obtained by eliminating the retaining structure for the permanent magnet bars 24 extending above or over the exposed face 42.

More generally, it will be understood that the present invention can be applied to either a rotor or a stator with the magnets being either inboard or outboard. The invention is applicable to both motors and generators providing similar electrical properties and is not limited to use in aircraft but useful in any application where weight and/or size is a concern and subject to high rotational forces. While the present invention eliminates the need for any material overlying the permanent magnet bars 24, it will be appreciated that this clamping mechanism may also be used with an additional retaining material so positioned, where the clamping mechanism reduces the necessary thickness of such overlying material.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom”, and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including”, and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An electric machine comprising:
a stator and a rotor, the rotor rotating about an axis relative to a stator and positioned proximate to the stator for magnetic interaction therewith; and
a magnet support assembly attached to one of the rotor or stator and providing:
(a) a tubular magnet backer;
(b) a series of axially extending permanent magnet bars arrayed about the axis on a surface of the tubular backer support to present exposed faces away from the tubular magnet backer, the magnet bars having axially opposed ends presenting end faces having an interior oblique angle with respect to the exposed face; and
(c) magnet retention wedges flanking the permanent magnet bars and having wedge faces with interior acute angles with respect to the exposed faces of the permanent magnet bars and positioned in contact with the end faces of the permanent magnet bars to press the permanent magnet bars against the tubular magnet backer as the wedges move together about the permanent magnet bars.

2. The electric machine of claim 1 wherein at least some magnet retention wedges provide axially opposed wedge faces with interior acute angles with respect to the exposed faces of the permanent magnet bars, the opposed wedge faces contacting corresponding axial ends of the permanent magnet bars.

3. The electric machine of claim 1 wherein the interior oblique angles are greater than 100° and wherein the interior acute angles are less than 80°.

4. The electric machine of claim 1 wherein the wedge faces are provided by continuous rings having an inner surface adjacent and conforming to a circumferential surface of the tubular magnet backer.

5. The electric machine of claim 4 wherein the inner surface of the continuous rings present a portion of a key and key way limiting axial movement of the inner surface with respect to the tubular magnet backer.

6. The electric machine of claim 4 wherein the rings are a composite material providing circumferential axial fibers.

7. The electric machine of claim 1 further including an adhesive joining the permanent magnet bars to the tubular magnet backer.

8. The electric machine of claim 1 wherein the permanent magnet bars provide a Halbach array in a progression around the axis.

9. The electric machine of claim 1 wherein the magnet bars are polyhedrons having all interior angles of no less than 80°.

10. The electric machine of claim 1 further including an adhesive material applied between the axially extending permanent magnet bars.

11. The electric machine of claim 1 wherein the exposed faces are directed away from the axis.

12. The electric machine of claim 1 wherein including an electromagnet assembly and wherein an air gap between the exposed faces of the magnet bars and structure of the electromagnet assembly is free of the intervening material of the wedges.

13. The electric machine of claim 1 further including a space-filling adhesive applied over the exposed faces of the permanent magnet bars to provide a circumferentially smooth surface for reduced air resistance.

14. The electric machine of claim 1 further including a composite material with circumferentially directed fibers applied over the exposed faces of the permanent magnet bars to provide a circumferentially smooth surface for reduced air resistance.
